(19) United States
(12) Patent Application Publication
(10) Pub. No.: US 2007/0210292 A1
(43) Pub. Date: Sep. 13, 2007

(54) Vehicle mounted self-aid jack system

(76) Inventors: Lei Zou, Shanghai (CN); Yun Zou, Shanghai (CN)

Correspondence Address: ANNA WU, P.O. BOX 93286, CITY OF INDUSTRY, CA, 91715, US

(21) Appl. No.: 11/376,841

(22) Filed: Mar. 16, 2006

(30) Foreign Application Priority Data
Mar. 7, 2006 (CN) 200610024439.3

(51) Int. Cl. B60S 9/02

(52) U.S. Cl. 254/423

(57) ABSTRACT

A jacking system mounted to a vehicle for selectively lifting up a portion of the vehicle relative to a ground, the jacking system includes two pairs of hydraulic jacks mounted to the vehicle, a hydraulic power assembly coupled in communication with the hydraulic jacks for providing a hydraulic fluid under pressure to selectively actuate the hydraulic jacks, and a control unit for activating a valve arrangement so as to selective shift each of the hydraulic jacks between a storage position and a load position, wherein at the load position, the fluid is pumped into hydraulic jack for lifting the vehicle, and at the storage position, the fluid is pumped into the hydraulic jacks from a reversing direction forcing the jack disengaged with the ground.

### BACKGROUND OF THE PRESENT INVENTION

1. Field of Invention

The present invention relates to hydraulic jacks, and more particularly, relates to vehicle mounted hydraulic jacking system for selectively and conveniently lifting the vehicle according to user's mind.

2. Description of Related Arts

Commonly, all vehicles are equipped with a portable, manually operable jack for lifting up the vehicle under certain circumstances, such as for replacing a flatted tire. There are at least two types of car jacks, namely hydraulic jacks and lever jacks. As its names implies, the hydraulic jack comprises a lifting arm moveably disposed in a base, a handle mounted to the base, and a fluid cylinder for receiving a hydraulic fluid and a piston connected to the lifting arm in such a manner that when the handle is reciprocally actuated for pumping the hydraulic fluid to drive the piston upwardly, the lifting arm is capable of being lifted to rise a load. Accordingly, the lever jack comprises a lift arm threadedly mounted to a base, and a lever arm coupled to the lift arm in such a manner that by rotating the lever arm, the lift arm is capable of being upwardly rotated and projected from the base so as to lift a load.

Generally, these two car jacks could be shifted between a storage position and a functional position. In case a user wished to replace a flatted tire, he or she would normally remove the jack from its storage position and dispose the jack under the vehicle's chassis. Regardless which kind of car jack was equipped with the vehicle, the user would have to manually and painstakingly crank or pump the jack from the storage position into the function so as to disengage the flatted tire from the ground. Subsequently, the user would replace the flatted tire with a spared tire. Finally, he or she would once again to release the jack from its functional position, and shift the jack back to the storage position. Needless to say, this tire changing process would be a time and labor consuming ordeal for the users, especially for a lady driver.

To solve this dilemma, some vehicles have been equipped with self-contained hydraulic jacks for elevating a predetermined portion of the vehicle to replace the flatted tire. The hydraulic jacks are easily attached to the vehicle chassis, respectively onto a front suspension frame and a rear suspension frame between wheels. Such jacks are electrically operated and powered by the vehicle battery, so that a user is able to raise or lower the front and rear suspension frames by operating the jack switches provided within the vehicle.

However, such vehicle self-contained jacks still have some drawbacks. For example, there are no locking sensors provided to such kind of jacks. The user or driver would have no clue to detect any failure functions of such jacks in advance. Since the hydraulic jacks are mounted to the bottom side of a vehicle, the actuating arms as well as the fluid cylinder of the hydraulic jacks are downwardly exposed to outside from time to time. As a result, it is highly possible the actuating arm of hydraulic jack would be fall off from the cylinder or hit an unexpected object during a road trip. Moreover, since the hydraulic jack is mounted onto the chassis of a vehicle, there is no enough space below the vehicle body to integrally and fittedly install such jacks. Generally, the components of the jacks are installed to the vehicle body with a separated manner. The oil guide tube of the fluid cylinder must be extended to be mounted onto the vehicle body. However, once the oil guide tube is broken, the hydraulic fluid will be leaked from the fluid cylinder. It is rather difficult to detect the sealing effect of such jacking system. Finally, in case of the vehicle self-contained jack was out of service, the user had to resort to another set of portable jack to lift up the vehicle.

### SUMMARY OF THE PRESENT INVENTION

A primary object of the present invention is to provide a vehicle mounted jacking system for selectively lifting up the vehicle in a convenient manner, wherein the jacking system comprise at least two hydraulic jacks each of which has a cylinder and an actuating arm received in the cylinder, wherein a bidirectional movement between the actuating arm and the cylinder could be locked up and secured by the user for ensuring an operation safety.

Another object of the present invention is to provide a vehicle mounted jacking system for selectively lifting up the vehicle in a convenient manner, wherein the hydraulic jacks are capable of being horizontally installed onto the vehicle body so as to prevent any abrupt and undesirable falling off of such jacks in routine applications.

Another object of the present invention is to provide a vehicle mounted jacking system for selectively lifting up the vehicle in a convenient manner, wherein the jacking system comprises a monitor unit installed on an operational panel, such that a user is able to check the sealing effect of all hydraulic jacks from time to time.

Another object of the present invention is to provide a vehicle mounted jacking system for selectively lifting up the vehicle in a convenient manner, wherein the jacking system could be manually and conveniently operated under certain circumstances.

Another object of the present invention is to provide a vehicle mounted jacking system for selectively lifting up the vehicle in a convenient manner, wherein the hydraulic jack could be horizontally received onto the chassis of the vehicle so as to save the storage space of such jacking system.

Another object of the present invention is to provide a vehicle mounted jacking system for selectively lifting up the vehicle in a convenient manner, wherein no complicated structures or expensive parts are required for achieving above mentioned objects.

Another object of the present invention is to provide a vehicle mounted jacking system, wherein each of the hydraulic jacks has a dual chamber cylinder for securely actuating a drive piston to raise a load while being energy effective.

Another object of the present invention is to provide a vehicle mounted jacking system, wherein such jacking system is operated by electrical means and powered by the vehicle equipped battery, such that the user are able to lift up the vehicle under certain circumstances without getting out of the vehicles.

Another object of the present invention is to provide a vehicle mounted jacking system, wherein the hydraulic fluid flowing into the hydraulic jacks via a bidirectional check valve, such that the jack could be locked up at any position preventing the drive arm suddenly dropped down.

Accordingly, to achieve above mentioned objects, the present invention provides a jacking system mounted to a vehicle for selectively lifting up a portion of the vehicle relative to a ground, comprising:

two pairs of hydraulic jacks mounted to the vehicle, namely, a pair of front jacks spacedly and symmetrically mounted to a front suspension frame of the vehicle in a substantially vertical orientation with respect to the ground, and a rear pair of jacks spacedly and symmetrically mounted to a rear suspension frame of the vehicle in a substantially horizontal orientation with respect to the ground;

wherein each of the jacks comprises a base frame mounted to the suspension frame, a hydraulic cylinder having an inner fluid chamber, and a piston shank having a driving portion movably disposed in the inner fluid chamber for dividing the inner fluid chamber into an upper compartment and a lower compartment, and a pusher head downwardly and solidly extended from the driving portion;

wherein each of the hydraulic cylinder of the front jacks is vertically oriented toward the ground, and each of the hydraulic cylinder of the rear jacks is horizontally oriented with respect to the ground and pivotally coupled to a grounding footing, such that when the jacking system is actuated, the front jack is downwardly moved towards the ground, and the rear jack is capable of pivotally lowering the grounding footing to reach to the ground;

a hydraulic power assembly coupled in communication with the hydraulic jacks for providing a hydraulic fluid under pressure to selectively actuate the hydraulic jacks, comprising a fluid reservoir for containing a predetermined volume of fluid, a manifold having a reversing valve arrangement coupled in fluid communication between the hydraulic jacks and the fluid reservoir, a power source, a pump for driving the fluid out of the fluid reservoir into the manifold, and a motor electrically connected to the power source for driving the pump into function; and

a control unit for activating the reversing valve so as to selective shift each of the hydraulic jacks between a storage position and a load position, wherein at the load position, the reversing valve is shifted to an up position, the fluid is pumped into the upper compartment of the inner fluid chamber forcing the driving portion of the piston shank move downwardly until the pusher head fully supported by the ground, and at the storage position, the reversing valve is shifted to a down position, the fluid is pumped into the lower compartment of the inner fluid chamber forcing the driving portion of the piston shank move upwardly until the pusher head fully disengaged with the ground;

### BRIEF DESCRIPTION OF THE DRAWINGS

FIG. 1 is a perspective view of the vehicle mounted hydraulic jacking system according to a preferred embodiment of the present invention.

FIG. 1A is a schematic view of the vehicle mounted hydraulic jacking system according to above preferred embodiment of the present invention showing the structure of the hydraulic jack.

FIG. 2 is a schematic view of the vehicle mounted hydraulic jacking system according to above preferred embodiment of the present invention showing the control unit.

FIG. 3 is a schematic view of the vehicle mounted hydraulic jacking system

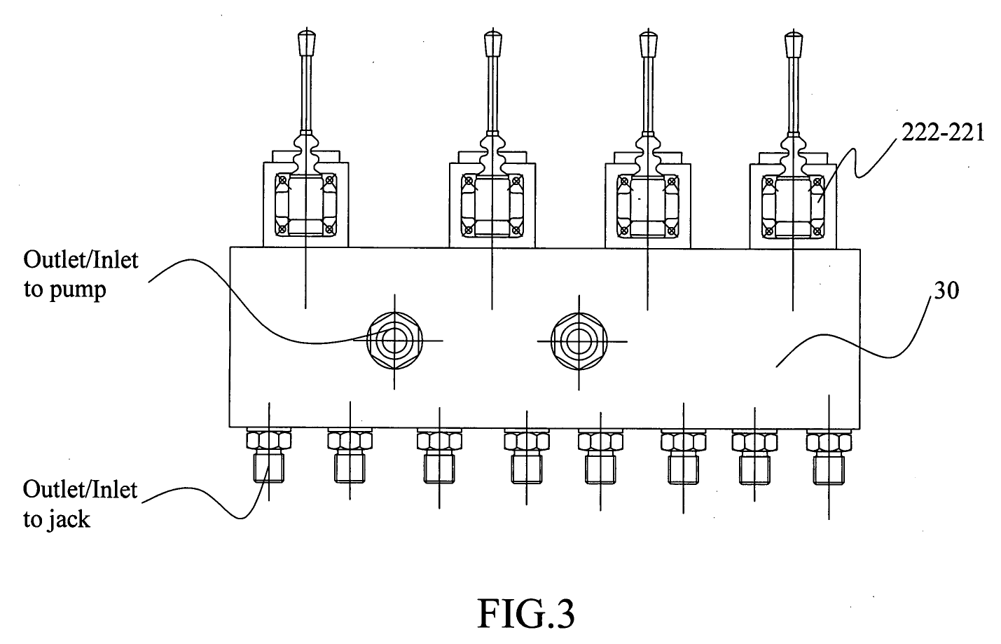

FIG. 4 is a schematic view of the vehicle mounted hydraulic jacking system according to above preferred embodiment of the present invention showing the structure of the horizontally displaced hydraulic jack.

FIG. 5 is a sectional view of the vehicle mounted hydraulic jacking system according to above preferred embodiment of the present invention showing the reversible locking arrangement of the hydraulic cylinder.

FIG. 6 is schematic view of the hydraulic jacks according to above preferred embodiment of the present invention illustrating the monitor sensor installed to the jacks for managing a safe operation.

### DETAILED DESCRIPTION OF THE PREFERRED EMBODIMENT

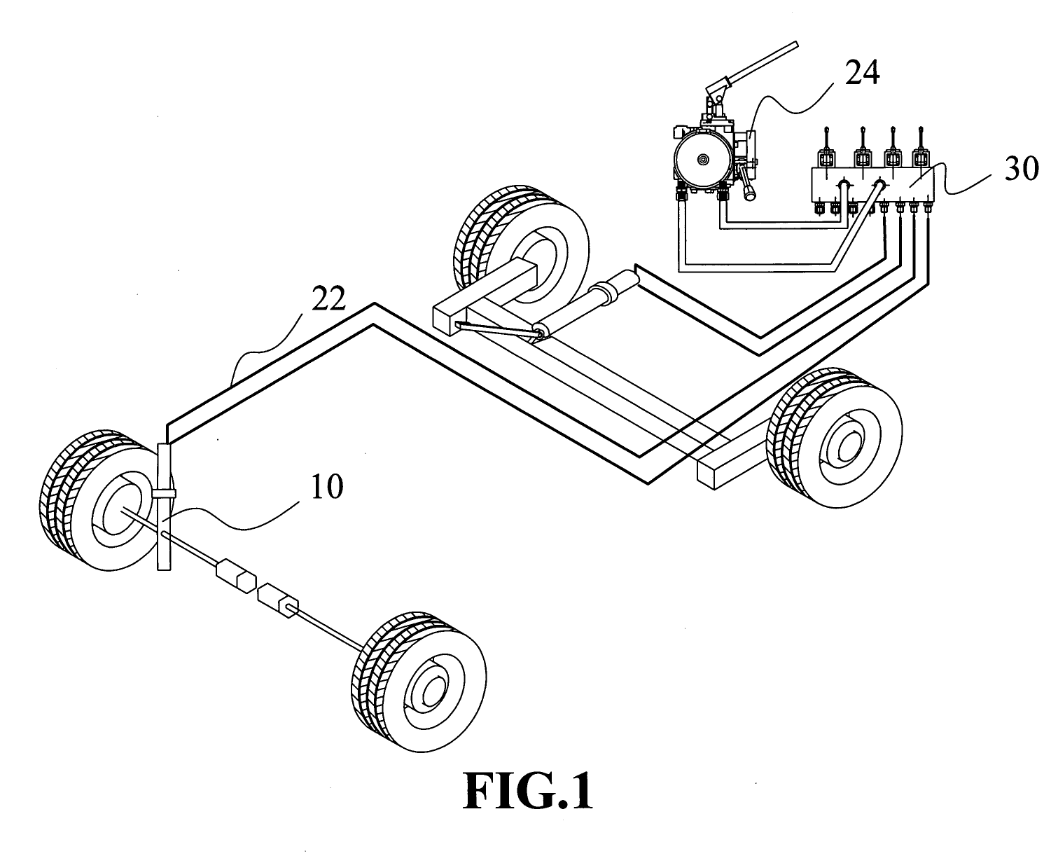

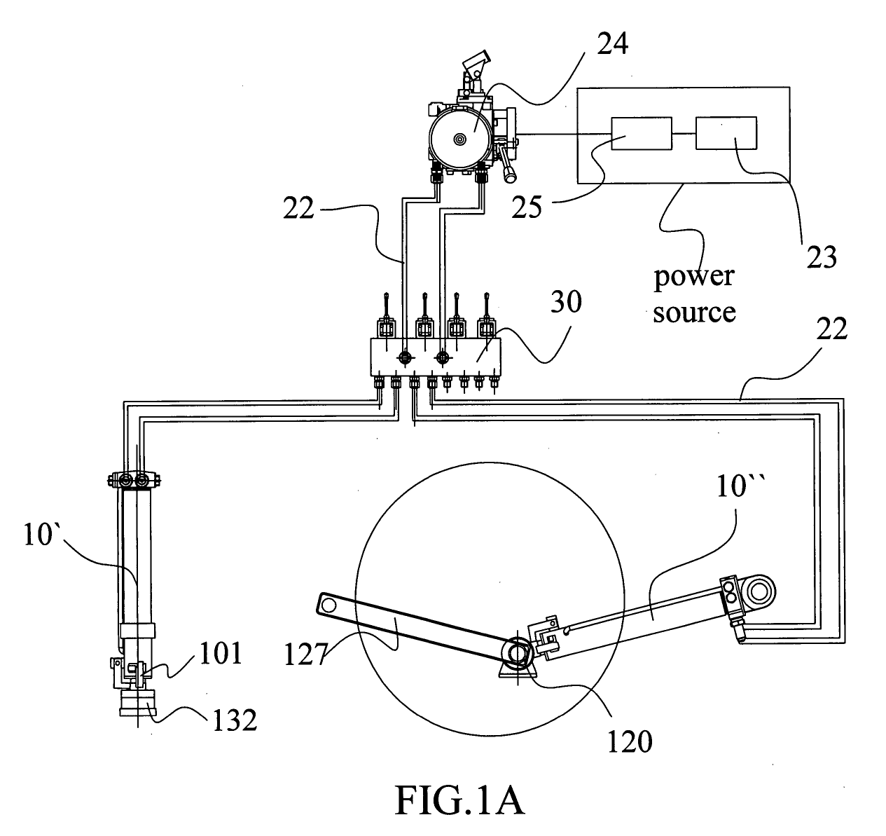

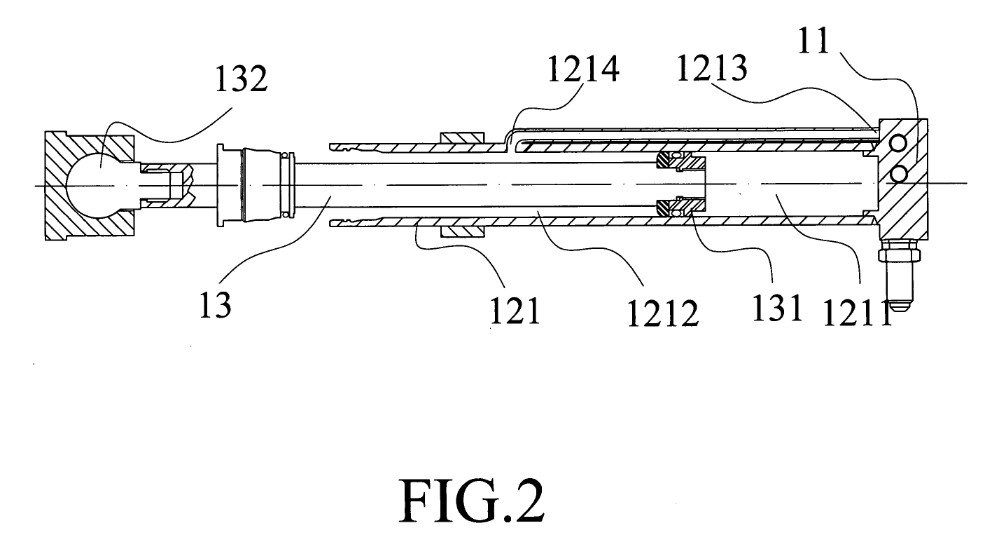

Referring to FIG. 1 and FIG. 2, the vehicle mounted jacking system according to a preferred embodiment of the present invention is illustrated. The jacking system is adapted to be mounted to a vehicle for selectively lifting up a portion of the vehicle relative to a ground. The jacking system 1 comprises two pairs of hydraulic jacks 10 mounted to a chassis 2 of the vehicle, namely, a front pair of jacks 10′ spacedly and symmetrically mounted to a front suspension frame of the vehicle in a substantially vertical orientation with respect to the ground, and a rear pair of jacks 10″ spacedly and symmetrically mounted to a rear suspension frame of the vehicle in a substantially horizontal orientation with respect to the ground.

Here, each of the hydraulic jacks 10 comprises a base frame 11, a hydraulic cylinder 12, having an inner fluid chamber 121, a piston shank 13 having a driving portion 131 movably disposed in the fluid chamber 121 for dividing the inner fluid chamber 121 into an upper compartment 1211 and a lower compartment 1212, and a pusher head 132 downwardly and solidly extended from the driving portion 131 towards the ground.

It is noted that each of the hydraulic cylinder 12 of the front jacks 11 is vertically oriented toward the ground, and each of the hydraulic cylinder 12′ of the rear jacks 12′ is horizontally oriented with respect to the ground and pivotally coupled to a grounding footing 120, such that when the jacking system is actuated, the front jacks 11 are downwardly moved towards the ground, and the rear jacks 11′ are capable of pivotally lowering the grounding footing 120 to reach to the ground;

The jacking system further comprises a hydraulic power assembly 20 coupled in communication with the hydraulic jacks 10 for providing a hydraulic fluid under pressure to actuate the hydraulic jacks 10. The hydraulic power assembly 20 comprises a fluid reservoir 21 for containing a predetermined volume of fluid, a manifold 22 having a reversing valve arrangement 221 coupled in fluid communication between the hydraulic jacks 10 and the fluid reservoir 21, a power source 23, a pump 24 for driving the fluid out of the fluid reservoir 21 into the manifold 22 and a motor 25 electrically connected to the power source 23 for driving the pump into function.

Moreover, the jacking system comprises a control unit 30 for activating the valve arrangement 221 so as to shift the hydraulic jacks 10 between a storage position and a load position, wherein at the load position, the reversing valve arrangement 221 is shifted to an up position, the fluid is pumped into the upper compartment 1211 of the inner fluid chamber 121 forcing the driving portion 131 of the piston shank 13 move downwardly until the pusher head 132 fully extended out, and at the storage position, the reversing valve arrangement 221 is shifted to a down position, the fluid is pumped into the lower compartment 1212 of the inner fluid chamber 121 forcing the driving portion 131 of the piston shank 13 move upwardly until the pusher head 132 backwardly received.

Here, each of the hydraulic jacks 10 is adapted to controllably raise and lower a portion of the vehicle relative to the ground. According to the preferred embodiment of the present invention, the control unit 30 is adapted to selectively guide the fluid flowing within the manifold into respective hydraulic jack 10 within a control manner.

Preferably, the reversing valve arrangement 221 of the manifold has at least four four-way directional check valves 222 defined thereon for selectively supplying the fluid to each of the hydraulic jacks 10 independently, while maintaining remaining hydraulic jacks independently hydraulically lockable. In other words, the hydraulic power assembly 20 provides hydraulic fluid under pressure for actuating hydraulic jacks 10.

Furthermore, the hydraulic cylinder 12 is double acting style actuating cylinder, which means that fluid under pressure could be applied to either side of the piston shank 13 to apply force and provide movement. As shown in FIG. 2, the hydraulic cylinder 12 is embodied as double-acting cylinder for controlling the vertical movement of the hydraulic jacks 10. The stroke of the piston shank 13 in either direction is produced by fluid pressure. Accordingly, there are two fluid ports, namely a first fluid port 1213 and a second fluid port 1214 provided adjacent to each end of the cylinder, respective located on the upper compartment 1211 and the lower compartment 1212, alternate as inlet and outlet ports, depending on the direction of the fluid flowing process.

That is to say, each of the inner fluid chambers 121 of the hydraulic jacks 10 has a first fluid port 1213 provided onto the upper compartment 1211 and a second fluid port 1214 provided onto the lower compartment 1212 respectively. At the storage position, the fluid is pumped into the inner fluid chamber 121 via the second fluid port 1214 forcing the piston shank 13 move upwardly, and accordingly, at the load position, the fluid is pumped into the inner chamber 121 via the first fluid port 1213.

Moreover, the valves arrangement 221 comprises a plurality of four-way directional check valves 222 for guiding the fluid flow in the manifold 22 with a manageable manner. According to a preferred embodiment of the present invention, the hydraulic cylinder 12 is referred as an unbalanced actuating cylinder because there is a difference in the effective working areas on the two sides of the piston shank 13.

More importantly, the plurality of four way directional check valves 222 disposed between the hydraulic jacks 10 and the fluid reservoir 21 for guiding the fluid flowing within the manifold 22 with a stable manner. As shown in FIG. 2, each of inner fluid chamber 121 is correspondingly mated with a four-way directional check valve 222 for guiding fluid flowing into the upper compartment 1211 and the lower compartment 1212. Whenever the fluid is selectively pumped into either the upper compartment 1211 or the lower compartment 1212, the four-way directional check valve 222 is adapted to block the fluid flowing from a reversed direction. For example, in case the fluid is guided by the control unit 30 to flow into the lower compartment 1212 for upwardly shifting the piston shank 13, the four way directional check valve 222 correspondingly mated with the upper compartment 1211 is blocked until the fluid loading pressure of the lower compartment 1211 reach a predetermined value thus forcing the valve opened allowing the fluid of the upper compartment 1211 flow back to the manifold 22 via the first port 1213 to circulate a loop between the hydraulic jack 10 and the fluid reservoir 21. It is noted that the predetermined value refers to a pressuring difference between the piston shank for substantially shifting the piston shank moveable within the inner fluid chamber 121.

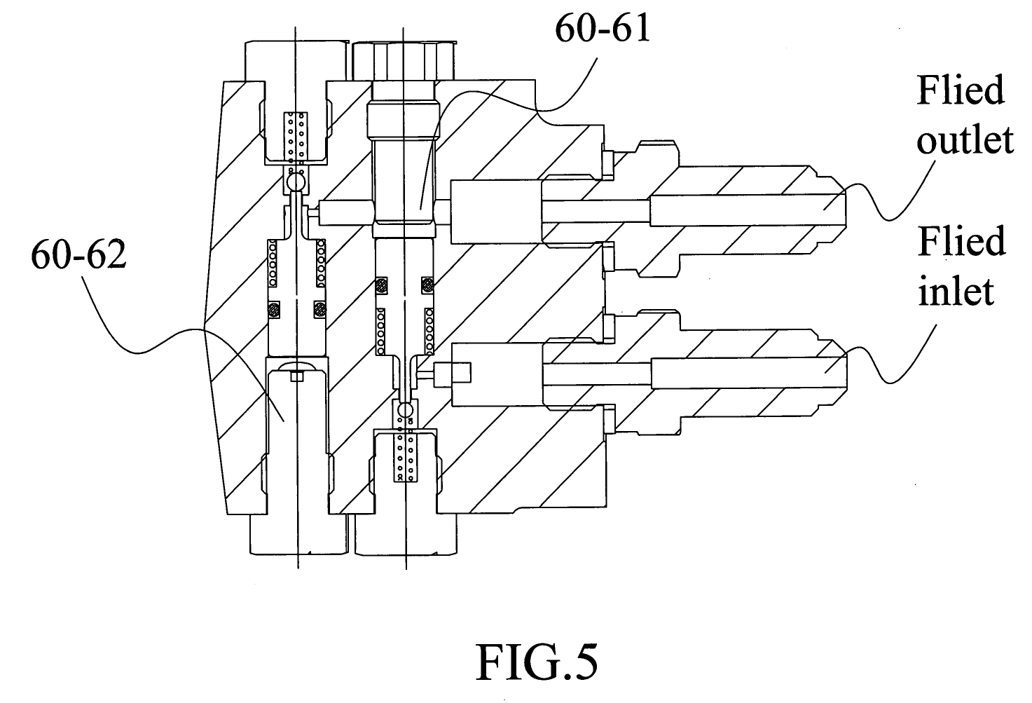

As shown in FIG. 5, each of the hydraulic jacks comprises at least a reversible locking arrangement 60 for maintaining the hydraulic cylinder fluid pressure within a predetermined value. The reversible locking arrangement 60 comprises at least an up-stream conduit 61 and a down-stream conduit 62 respectively communicating with the fluid inlet and fluid outlet of the hydraulic cylinder, wherein each of the up-stream and down-stream conduit is symmetrically and reversibly equipped with a fluid plugging valve for locking up the fluid flowing process at certain position.

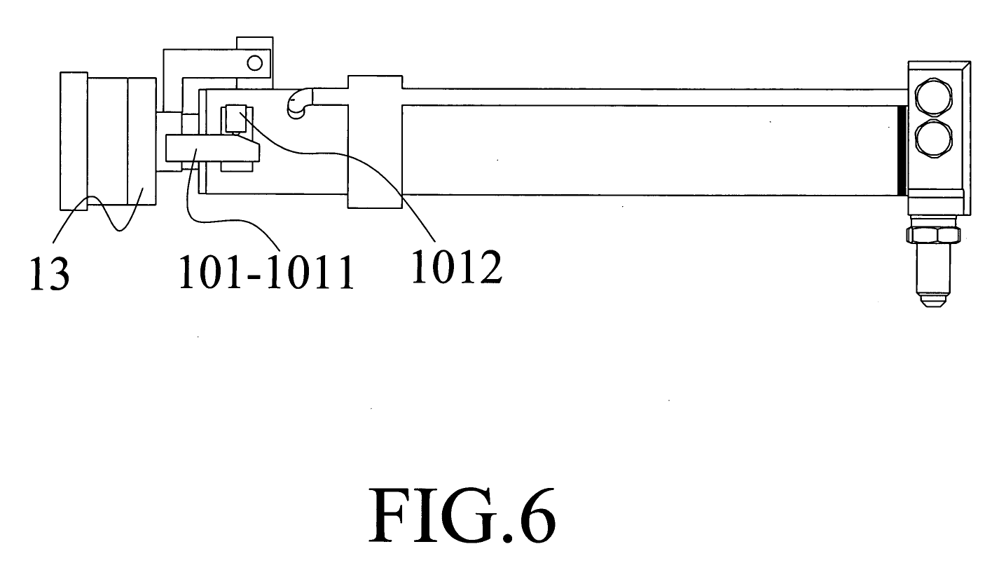

Moreover, as shown in FIG. 6, each of the hydraulic jacks 10 of the jacking system further comprises a leaking detector 101 mounted thereon for preemptively transmitting a warning signal to the user. The leaking detector 101 comprises a detector sensor 1011 mounted onto a lower end of the piston shank 13, and a detector transmitter correspondingly provided at a matching lower portion of the hydraulic cylinder 12, such that whenever the piston shank 13 is inadvertently and downwardly slipped along the inner wall of the hydraulic cylinder 12 under a leaking circumstance, the detector sensor 1011 and the detector transmitter 1012 would be engaged thus enabling the detector 1012 transmitting a warning single to the user.

The manifold 22 further comprises a primary line 224 for communicating the fluid reservoir 21 and the reversing check arrangement 221, and a secondary line 225 for collectively communicating the four hydraulic jacks 10 and the reversing valve arrangement 221. Moreover, the secondary line 225 further comprises a common line 2251 for pouring the fluid into respective hydraulic jack 10 and four return lines 2252 for displacing the fluid back to the common line 2251. Preferably, the four-way directional check valve 222 could be positioned to direct fluid under pressure to either ends of the hydraulic cylinder 12 and allow the displaced fluid to flow from the opposite end of the hydraulic cylinder 12 through the four way directional check valve 222 to the return line 2252.

To sum up, the fluid is directed through ports 1213, 1214 by a four-way directional control valve 222 and move the piston shank 13 within the inner fluid chamber 121, thus moving the pusher head 12 or grounding footing 12′ engage/disengage with the ground. The fluid on either side of the piston shank 13 is forced out of the cylinder through first fluid port 1213 and the second fluid port 1214, which is connected by a common line 2251 to the four-way directional check valve 223. The displaced fluid then flows through the four-way directional control valve 223 to the return line 2252.

Accordingly, the hydraulic cylinder 12 of each hydraulic jack 10 is fluid tight, and the piston shank 13 is telescopically received within the inner fluid chamber 121 of the hydraulic cylinder 12. As a result, by selectively pumping the fluid flowing within the common line 2251 into the upper compartment 1211 or the lower compartment 1212 of the inner fluid chamber 121, the vertically orientated piston shank 13 is capable of being extracted from the hydraulic cylinder 12 so as to stand the vehicle onto the ground with a rigid manner or received within the inner fluid chamber 121 according to user's mind.

Referring now to FIGS. 1 and 2, the pump 24 and the motor 25 are integrally formed and disposed underneath the vehicle. Accordingly, a mounting bracket 26 is provided for mounting the pump 24 and motor 25 to the vehicle. It is noted that the mounting bracket 26 is arranged to upwardly sustain the pump 24 and the motor 25 in position. That is to say, the mounting bracket 26 is supposed to directly expose to the ground thus protecting the pump and the motor from being damaged.

Here, the primary line 224 further comprises a fluid supply line 2241 for communicating the fluid reservoir 21 to the pump 24. Accordingly, a check valve 2242 is mounted within fluid supply line 2241 for providing one-way flow of fluid from the pump 24 through the fluid supply line 2241 to the primary line 2241 of the manifold 22.

In other words, the hydraulic power assembly 20 adapted to ensure the fluid reservoir 21 being connected in bidirectional communication with the manifold 22. According to the preferred embodiment of the present invention, the hydraulic power assembly 20 is hydraulic power steering system of vehicle, which uses the vehicle's engine for its power source. More importantly, the reversing valve arrangement 221 and the control unit 30 are provided to the manifold 22 with a manual override. In case of power shortage, a manual actuating means 32 is provided by the present invention to activate the hydraulic power assembly 20 so as to enable the pump 24 to suck the fluid from the fluid reservoir 21 into the manifold 22.

The manual actuating means 32 comprises a hand crank 321 having a first end 3211 and a second end 3212, wherein the first end 3211 is rotatably coupled to the pump 24, and the second hand 3212 has a gripping portion to be grasped by a human hand. When the electrical power of the vehicle is failed, a user is able to crank the second end 3212 to activate the pump 24.

What is more, the control unit 30 further comprises a monitor valve 33 provided within the secondary line 225 for substantially monitoring the fluid pressure within each hydraulic jack 10. In case of an abnormal fluid pressure is detected by the monitor valve 33, the monitor sensor would be automatically activated enabling the fluid flow back to the fluid reservoir 21 for protecting the fluid pressure from being overheated leading to any undesirable accidents. That is to say, the monitor sensor is embodied as an overheating warning device for preventing an accident from being happened. The indicator of the monitor valve 33 could be provided at a position adjacent to the reversing valve arrangement 221 for a convenient maneuver or provided within driving room of the vehicle for an in-time alerting.

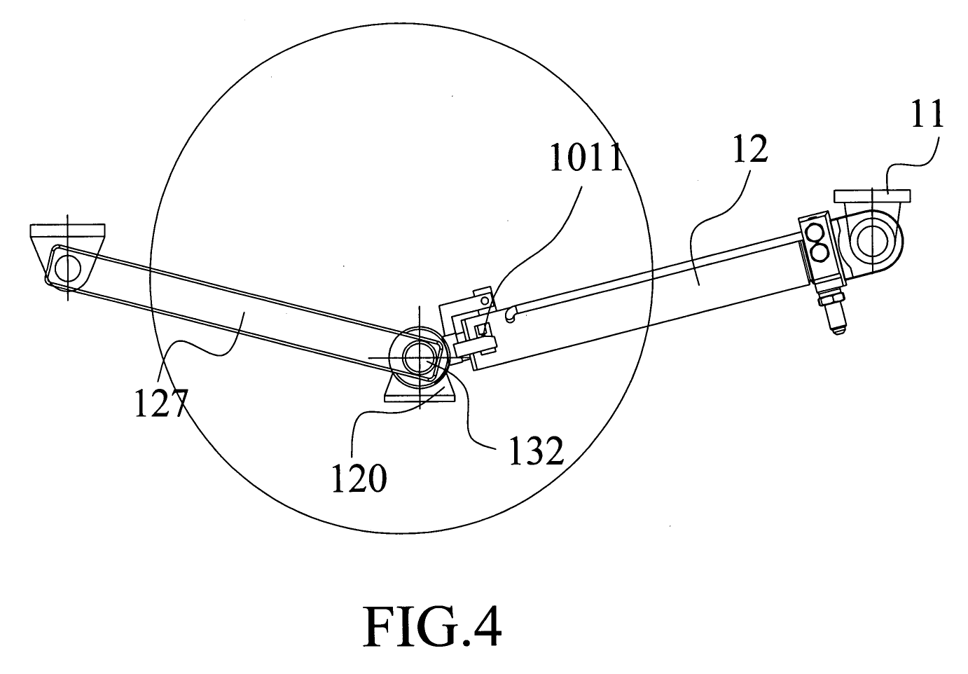

As shown in FIG. 4, the horizontally mounted hydraulic jack is illustrated according to a preferred embodiment of the present invention. The hydraulic cylinder 12 is disposed parallel with respect to the ground, wherein the hydraulic cylinder 12 has a connecting end pivotally coupled the base frame 11 and a supporting end securely mounted to the ground footing 120. Furthermore, there is a pivot arm 127 symmetrically provided to the rear suspension frame for commonly activating the ground footing 120. That is to say, like the hydraulic cylinder 12, the pivot arm 127 also has a first end pivotally coupled to a base frame 11 extended from the rear chassis of the vehicle, and a second end securely mounted to the ground footing 120. As a result, whenever the hydraulic cylinder 12 is activated, the pusher head 132 would be outwardly extended out from the hydraulic cylinder 12 thus forcing the ground footing 120 downwardly orienting towards the ground. Since both of the hydraulic cylinder and the pivot arm are pivotally coupled to the base frame 11, the downwardly lowered ground footing 120 would enable the pivot arm 127 and the hydraulic cylinder 12 from an elongated shape gradually collapsed to form V-shaped structure, wherein the ground footing 120 would be embodied as the lower point of V-shape for supporting the vehicle body in position.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A jacking system mounted to a vehicle for selectively lifting up a portion of said vehicle relative to a ground, comprising:
two pairs of hydraulic jacks mounted to said vehicle, namely, a pair of front jacks spacedly and symmetrically mounted to a front suspension frame of said vehicle in a substantially vertical orientation with respect to said ground, and a rear pair of jacks spacedly and symmetrically mounted to a rear suspension frame of said vehicle in a substantially horizontal orientation with respect to said ground;
wherein each of said jacks comprises a base frame mounted to said suspension frame, a hydraulic cylinder having an inner fluid chamber, and a piston shank having a driving portion movably disposed in said inner fluid chamber for dividing the inner fluid chamber into an upper compartment and a lower compartment, and a pusher head downwardly and solidly extended from said driving portion;
wherein each of said hydraulic cylinder of said front jacks is vertically oriented towards said ground, and each of the hydraulic cylinder of said rear jacks is horizontally oriented with respect to said ground and pivotally coupled to a grounding footing, such that when said jacking system is actuated, said front jack is downwardly moved towards said ground, and said rear jack is capable of pivotally lowering said grounding footing to reach said ground;
a hydraulic power assembly coupled in communication with said hydraulic jacks for providing a hydraulic fluid under pressure to selectively actuate said hydraulic jacks, comprising a fluid reservoir for containing a predetermined volume of fluid, a manifold having a reversing valve arrangement coupled in fluid communication between said hydraulic jacks and said fluid reservoir, a power source, a pump for driving said fluid out of said fluid reservoir into said manifold, and a motor electrically connected to said power source for driving said pump into function; and
a control unit for activating said reversing valve so as to selective shift each of said hydraulic jacks between a storage position and a load position, wherein at said load position, said reversing valve arrangement is shifted to an up position, the fluid is pumped into said upper compartment of said inner fluid chamber forcing said driving portion of said piston shank move downwardly until said pusher head fully supported by said ground, and at said storage position, said reversing valve is shifted to a down position, said fluid is pumped into said lower compartment of said inner fluid chamber forcing said driving portion of said piston shank move upwardly until said pusher head fully disengaged with said ground.

2. The jacking system, as recited in claim 1, wherein said reversing valve arrangement further comprises a plurality of four-way directional check valves for guiding said fluid flow in said manifold with a manageable manner, wherein each said inner fluid chamber is correspondingly mated with one of said four-way directional check valves for guiding fluid flowing into said upper compartment and said lower compartment.

3. The jacking system, as recited in claim 2, wherein each of said check valves is capable of supplying of said fluid to said hydraulic jacks during a operation of said pump and prevent flow of said fluid to said fluid reservoir while said pump is not operating.

4. The jacking system, as recited in claim 1, wherein said hydraulic cylinder is double acting style actuating cylinder, wherein said fluid under pressure is applied to either side of said piston shank to apply force and provide movement, said inner fluid chamber further comprises two fluid ports, namely a first fluid port and a second fluid port respectively located on said upper compartment and said lower compartment, alternate as inlet and outlet ports for a fluid flowing process.

5. The jacking system, as recited in claim 3, wherein said hydraulic cylinder is double acting style actuating cylinder, wherein said fluid under pressure is applied to either side of said piston shank to apply force and provide movement, said inner fluid chamber further comprises two fluid ports, namely a first fluid port and a second fluid port respectively located on said upper compartment and said lower compartment, alternate as inlet and outlet ports for a fluid flowing process.

6. The jacking system, as recited in claim 1, wherein each of said hydraulic jacks comprises at least a reversible locking arrangement for maintaining a hydraulic cylinder fluid pressure within a predetermined value, said reversible locking arrangement comprises at least an up-stream conduit and a down-stream conduit respectively communicating with said fluid inlet and fluid outlet of said hydraulic cylinder, wherein each of said up-stream and said down-stream conduit is symmetrically and reversibly equipped with a fluid plugging valve for locking up said piston shank at certain position.

7. The jacking system, as recited in claim 4, wherein each of said hydraulic jacks comprises at least a reversible locking arrangement for maintaining a hydraulic cylinder fluid pressure within a predetermined value, said reversible locking arrangement comprises at least an up-stream conduit and a down-stream conduit respectively communicating with said fluid inlet and fluid outlet of said hydraulic cylinder, wherein each of said up-stream and said down-stream conduit is symmetrically and reversibly equipped with a fluid plugging valve for locking up said piston shank at certain position.

8. The jacking system, as recited in claim 5, wherein each of said hydraulic jacks comprises at least a reversible locking arrangement for maintaining a hydraulic cylinder fluid pressure within a predetermined value, said reversible locking arrangement comprises at least an up-stream conduit and a down-stream conduit respectively communicating with said fluid inlet and fluid outlet of said hydraulic cylinder, wherein each of said up-stream and said down-stream conduit is symmetrically and reversibly equipped with a fluid plugging valve for locking up said piston shank at certain position.

9. The jacking system, as recited in claim 1, wherein said hydraulic power assembly further comprises a manual actuating means for activating said hydraulic power assembly to enable said pump to suck said fluid from said fluid reservoir into said manifold, said manual actuating means comprises a hand crank having a first end and a second end, wherein said first end is rotatably coupled to said pump, and said second end has a gripping portion to be grasped by a human hand to activate said pump.

10. The jacking system, as recited in claim 2, wherein said hydraulic power assembly further comprises a manual actuating means for activating said hydraulic power assembly to enable said pump to suck said fluid from said fluid reservoir into said manifold, said manual actuating means comprises a hand crank having a first end and a second end, wherein said first end is rotatably coupled to said pump, and said second end has a gripping portion to be grasped by a human hand to activate said pump.

11. The jacking system, as recited in claim 4, wherein said hydraulic power assembly further comprises a manual actuating means for activating said hydraulic power assembly to enable said pump to suck said fluid from said fluid reservoir into said manifold, said manual actuating means comprises a hand crank having a first end and a second end, wherein said first end is rotatably coupled to said pump, and said second end has a gripping portion to be grasped by a human hand to activate said pump.

12. The jacking system, as recited in claim 6, wherein said hydraulic power assembly further comprises a manual actuating means for activating said hydraulic power assembly to enable said pump to suck said fluid from said fluid reservoir into said manifold, said manual actuating means comprises a hand crank having a first end and a second end, wherein said first end is rotatably coupled to said pump, and said second end has a gripping portion to be grasped by a human hand to activate said pump.

13. The jacking system, as recited in claim 1, further comprising a monitor valve provided with said manifold for monitoring a fluid pressure so as to prevent an accident from being happened.

14. The jacking system, as recited in claim 4, further comprising a monitor valve provided with said manifold for monitoring a fluid pressure so as to prevent an accident from being happened.

15. The jacking system, as recited in claim 9, further comprising a monitor valve provided with said manifold for monitoring a fluid pressure so as to prevent an accident from being happened.

16. The jacking system, as recited in claim 1, wherein each of said hydraulic jacks further comprises a leaking detector for preemptively transmitting a leak warning signal, said leaking detector comprises a detector sensor mounted onto a lower end of said piston shank, and a detector transmitter correspondingly provided at a matching lower position of said hydraulic cylinder, such that whenever said piston shank is inadvertently and downwardly slipped along said hydraulic cylinder under a leaking circumstance, said detector sensor and said detector transmitter would be engaged thus enabling said detector transmitter transmitting a warning signal in advance.

17. The jacking system, as recited in claim 4, wherein each of said hydraulic jacks further comprises a leaking detector for preemptively transmitting a leak warning signal, said leaking detector comprises a detector sensor mounted onto a lower end of said piston shank, and a detector transmitter correspondingly provided at a matching lower position of said hydraulic cylinder, such that whenever said piston shank is inadvertently and downwardly slipped along said hydraulic cylinder under a leaking circumstance, said detector sensor and said detector transmitter would be engaged thus enabling said detector transmitter transmitting a warning signal in advance.

18. The jacking system, as recited in claim 6, wherein each of said hydraulic jacks further comprises a leaking detector for preemptively transmitting a leak warning signal, said leaking detector comprises a detector sensor mounted onto a lower end of said piston shank, and a detector transmitter correspondingly provided at a matching lower position of said hydraulic cylinder, such that whenever said piston shank is inadvertently and downwardly slipped along said hydraulic cylinder under a leaking circumstance, said detector sensor and said detector transmitter would be engaged thus enabling said detector transmitter transmitting a warning signal in advance.

19. The jacking system, as recited in claim 9, wherein each of said hydraulic jacks further comprises a leaking detector for preemptively transmitting a leak warning signal, said leaking detector comprises a detector sensor mounted onto a lower end of said piston shank, and a detector transmitter correspondingly provided at a matching lower position of said hydraulic cylinder, such that whenever said piston shank is inadvertently and downwardly slipped along said hydraulic cylinder under a leaking circumstance, said detector sensor and said detector transmitter would be engaged thus enabling said detector transmitter transmitting a warning signal in advance.

20. The jacking system, as recited in claim 13, wherein each of said hydraulic jacks further comprises a leaking detector for preemptively transmitting a leak warning signal, said leaking detector comprises a detector sensor mounted onto a lower end of said piston shank, and a detector transmitter correspondingly provided at a matching lower position of said hydraulic cylinder, such that whenever said piston shank is inadvertently and downwardly slipped along said hydraulic cylinder under a leaking circumstance, said detector sensor and said detector transmitter would be engaged thus enabling said detector transmitter transmitting a warning signal in advance.
